(19) United States
(12) Patent Application Publication
(10) Pub. No.: US 2009/0122344 A1
(43) Pub. Date: May 14, 2009

(54) Image processing apparatus and control method thereof

(75) Inventors: Shunsuke Oi, Matsumoto-shi (JP); Shoji Kojima, Chino-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/291,780

(22) Filed: Nov. 13, 2008

(30) Foreign Application Priority Data
Nov. 13, 2007 (JP) 2007-294097

(51) Int. Cl. G06F 3/12

(52) U.S. Cl. 358/1.15

(57) ABSTRACT

An image processing apparatus, connected to a display apparatus so as to receive an image containing characters and to output the received image at a reduction rate which is set, includes a character size determination unit which determines a character size of an image which is received, a display control unit which displays a reduction rate-related setting screen for performing a reduction rate-related setting which is related to the reduction rate to the display apparatus on the basis of the determined character size so that a recommended reduction rate-related setting in which a character size of an output image is in a predetermined range and a non-recommended reduction rate-related setting which is other than the recommended reduction rate setting can be distinguishable from each other, and a reduction rate-related setting receiving unit which receives the reduction rate-related setting using the reduction rate-related setting screen.

This application claims priority under 35 U.S.C. §119 to Japanese Application No. 2007-294097 filed on Nov. 13, 2007, which is hereby incorporated by reference in its entirety.

### BACKGROUND

1. Technical Field

Image processing apparatus and a control method thereof.

2. Related Art

From the past, as a kind of image processing apparatuses, apparatuses which copy a document read by a scanner by reducing an image of the document at a reduction rate have been known (for example, refer to Patent document 1). These apparatuses allow a user to set a reduction rate by manipulating a zoom down key, etc. Further, with these apparatuses, N pages of document, which are read, can be copied into one page. That is, a method of N UP copy is known (for example, refer to Patent document 2). With these apparatuses, a user can set the number N (the number of pages of document to be combined into a single page)
[Patent document 1] JP-A-2002-196622
[Patent document 2] JP-A-2005-079830

However, if a user sets a relatively large reduction rate or a relatively large number N, the characters obtained after copying are reduced and become illegible. In this situation, the characters are likely to be reduced beyond recognition. While a user sometimes sets a reduction rate or a number N by considering the character size of a document so as not to cause such a problem, sometimes users simply set the reduction rate by following the hunches. Therefore, sometimes it is difficult to know whether the characters obtained after copying are illegible until the document is actually copied. Accordingly, users must copy the document again while changing settings many times. As a result, it takes an immense amount of time and effort to perform settings and a large amount of paper and ink are wasted.

### SUMMARY

An object of at least one embodiment of the invention is to provide an image processing apparatus and a control method thereof which allows a user to set a reduction rate suitable for copying.

The image processing apparatus and the control method of at least one embodiment has the following structure and steps in order to accomplish the above-mentioned object.

An image processing apparatus connected to a display apparatus so as to receive an image containing characters and to output the received image at a reduction rate which is set, the image processing apparatus including a character size determination unit which determines a character size of the received image, a display control unit which displays a reduction rate-related setting screen for performing a reduction rate-related setting which is related to the reduction rate to the display apparatus on the basis of the determined character size in a manner such that a recommended reduction rate-related setting in which a character size of an output image is in a predetermined range and a non-recommended reduction rate-related setting other than the recommended reduction rate-related setting are distinguishable from each other, and a reduction rate-related setting receiving unit which receives the reduction rate-related setting using the reduction rate-related setting screen.

In the image processing apparatus according to at least one embodiment of the invention, the character size of the received image is determined, the reduction rate-related setting screen for performing setting of the reduction rate-related setting which is related to the reduction rate is displayed on the display apparatus on the basis of the determined character size in such a manner that the recommended reduction rate-related setting in which the character size of the output image is in the predetermined range and the non-recommended rate-related setting other than the recommended rate-related setting are distinguishable. With this apparatus, a user can determine the recommended reduction rate-related setting and the non-recommended reduction rate-related setting in one glance. Accordingly, it is possible to provide a user with a setting related to a reduction rate suitable for copying. Here, “determination of a character size” includes determination of a character point number. If a user sets a range in which characters obtained after copying are legible as a “predetermined range,” the characters obtained after copying are not likely to be illegible.

In the image processing apparatus according to at least one embodiment of the invention, it is preferable that the display control unit is a unit for performing a recommended reduction rate-related setting in which a character size of an output image is not smaller than a predetermined size as the recommended rate-related setting which is in the predetermined range. Here, if a user sets a size of the characters obtained after copying to a minimum character size as a “predetermined size” as long as the minimum character size is not illegible, there is no chance that the characters obtained after copying will be illegible. For example, about 6 point is set as the minimum character size from the point of view of the point number.

In the image processing apparatus according to at least one embodiment of the invention, it is preferable that the reduction rate-related setting is a setting for determining the number of images to be combined when outputting a plurality of received images by combining the received images into one image. With this method, it is possible to determine the number of recommended images and the number of non-recommended images in one glance. Accordingly, it is possible to provide a user with the number of images, which is suitable for copying.

In the image processing apparatus at least one embodiment of, it is preferable that an input size of the received image with respect to an output size be set. Here, the term “input size” and the term “output size” are standard sizes. For example, the input size and the output size are expressed by A4 or L-size. In this manner, the recommended output size and the non-recommended output size with respect to the input size can be determined in one glance. Accordingly, the output size suitable for copying can be provided to the user.

In the image processing apparatus according to the invention, it is preferable that the character size determination unit be a unit which detects character string direction edges of the received image and extracts an area in which the detected character string direction edges gather in a perpendicular direction as a character string, which detects perpendicular direction edges which are perpendicular to the extracted character string and extracts an area in which the perpendicular direction edges gather in the character string direction, and which determines a character size on the basis of a width of the extracted character string and a width of the extracted character. In this manner, it is possible to precisely determine the character size. Accordingly, it is possible to precisely determine the recommended reduction rate-related setting. In the image processing apparatus according to this aspect of at least one embodiment of the invention, it is preferable that the character size determination unit is a unit for determining the character size on the basis of a width when a width of the extracted character string equals to a width of the extracted character. With this structure, it is possible to precisely determine the character size on the basis of a width of the character having a quadrate shape. Accordingly, it is possible to precisely determine the recommended reduction rate-related setting.

In the image processing apparatus according to at least one embodiment of the invention, it is preferable that the display control unit be a unit for displaying a predetermined warning screen to the display unit when the reduction rate-related setting received by the reduction rate-related setting receiving unit is the non-recommended reduction rate-related setting. In this manner, it is possible to prevent a user from performing missetting.

A control method of an image processing apparatus connected to a display apparatus so as to receive an image containing characters and to output the received image at a set reduction rate, which is implemented by software of a computer and includes (a) determining a character size of the received image, (b) displaying a reduction rate-related setting screen for performing setting of a reduction rate-related setting which is related to the reduction rate on the basis of the character size determined by the step (a) on the display apparatus in such a manner that a recommended reduction rate-related setting in which a character size of an output image is in a predetermined range and a non-recommended reduction rate-related setting which is other than the recommended reduction rate-related setting are distinguishable from each other, and (c) receiving the reduction rate-related setting using the reduction rate-related setting screen.

In the control method of an image processing apparatus, the character size of the received image is determined, and then the reduction rate-related setting screen for performing a reduction rate-related setting which is related to the reduction rate on the basis of the determined character size is displayed on the display apparatus so that the recommended reduction rate-related setting in which a character size of an output image is in a predetermined range and the non recommended reduction rate-related setting which is other than the recommended reduction rate-related setting are distinguishable, and finally the reduction rate-related setting is received using the reduction rate-related setting screen. With such a method, a user can determine the recommended reduction rate-related setting and the non-recommended reduction rate-related setting in one glance. Accordingly, it is possible to allow a user to perform a setting of a reduction rate which is suitable for copying. Here, the term “determination of a character size” includes determination of a character point number. If the term “predetermined range” means a range in which the characters obtained after copying are not illegible for a user, there is no chance that the characters obtained after copying will be illegible. The image control method of an image processing apparatus according to the invention may include a step of realizing any of functions of the above-mentioned image processing apparatus.

### BRIEF DESCRIPTION OF THE DRAWINGS

The invention will be described with reference to the accompanying drawings, wherein like numbers reference like elements.

FIG. 1 is a schematic view illustrating an overall structure of a multi-function printer 10.

FIG. 2 is a block diagram illustrating the multi-function printer 10.

FIG. 3 is a flowchart illustrating an example of a copy mode processing routine.

FIG. 4 is a flowchart illustrating an example of a character point number determination processing.

FIG. 5 is an explanatory view illustrating an example of a sub-scanning direction histogram.

FIG. 6 is an explanatory view illustrating the relationship between a width of a character and a character point number.

FIG. 7 is an explanatory view illustrating an example of a main-scanning direction histogram.

FIG. 8 is an explanatory view illustrating the relationship between a character point number and a recommended maximum reduction rate Rmax.

FIG. 9 is an explanatory view illustrating an example of a copy setting screen 70.

FIG. 10 is an explanatory view illustrating whether the relationship between a character point number P and adequacy of 2 UP, or 4 UP.

FIG. 11 is an explanatory view illustrating the relationship between a character point number P and adequacy of a document size or paper size.

FIG. 12 is an explanatory view illustrating an example of a warning message displayed on a display portion 52.

FIG. 13 is an explanatory view illustrating an example of a copy setting screen 70.

### DESCRIPTION OF EXEMPLARY EMBODIMENTS

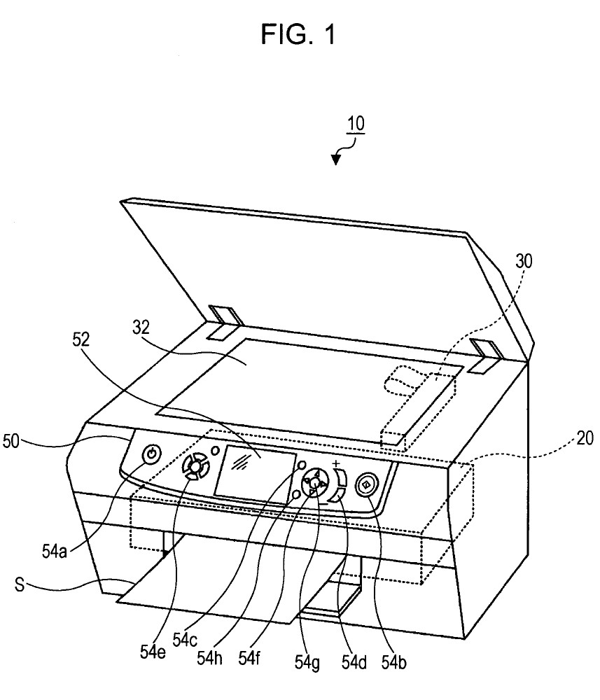

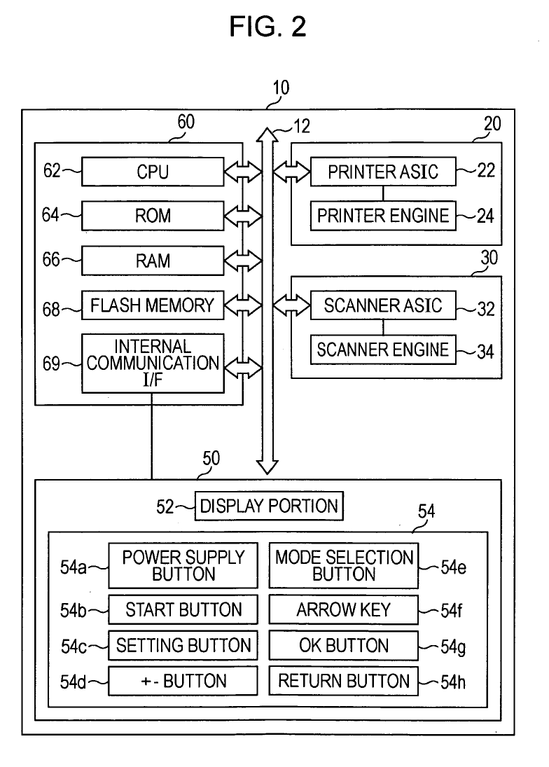

Next, embodiments of the invention will be described with reference to the accompanying drawings. FIG. 1 is a schematic view illustrating a structure of a multi-function printer 10. FIG. 2 is a block diagram illustrating the multi-function printer 10.

The multi-function printer 10 according to one embodiment of the invention, as shown in figures, includes a printer unit 20 which performs printing on paper S on the basis of a printing job, a flat head-type scanner unit 30 which reads a document P mounted on a document plate 32, a manipulation panel 50 which displays various kinds of information on a display portion 52 and receives a user's instructions by manipulations of buttons 54a-54g, and a main controller 60 which controls the whole apparatus. As shown in FIG. 2, in the multi-function printer 10, the printer unit 20 or the scanner unit 30, and the main controller 60 are structured to exchange various kinds of control signals and data via buses 12.

The printer unit 20 includes a printer ASIC 22 and a printer engine 24. The printer ASIC 22 is an integrated circuit, which controls the printer engine 24. The printer ASIC 22 controls the printer engine 24 in such a manner that the printer engine 24 performs printing on paper S on the basis of an image file which is an object of a print instruction when it receives the print instruction from the main controller 60. The printer engine 24 is constructed by a known ink-jet-type color printer mechanism which performs printing by discharging ink to paper from a print head. The ASIC is an abbreviation of Application Specific Integrated Circuit.

The scanner unit 30 includes a scanner ASIC 32 and a scanner engine 34. The scanner ASIC 32 is an integrated circuit which controls the scanner engine 34. When the scanner ASIC 32 receives a scan instruction from the main controller 60, it controls the scanner engine 34 so as to read a document P mounted on a document plate 32 as image data. The scanner engine 34 is constructed by a known image scanner and includes a known color image sensor which emits light toward the document P and splits the reflected light into colors, red (R), green (G), and blue (B).

The manipulation panel 50 includes the display portion 52 and the buttons 54. The display portion 52 is a liquid crystal display and displays various kinds of screens which allow a user to select a menu item and perform various kinds of settings. The buttons 54 include a power supply button 54a which turns on and off a power supply, a start button 54b which instructs to start copying, a setting button 54c for performing various kinds of print settings and copy settings, a “+−” button 54d for setting the number of copies of print or copy with respect to the selected image, and a reduction or magnification rate of a certain copy, a mode selection button 54e for selecting one mode from various modes, arrow keys 54f including up and down keys, a left key, and a write key for allowing selection of each item or setting, an OK button 54g which makes the selected setting effect, and a return button 54h for returning a display to a previous screen. The buttons 54 are made in such a manner that instructions from a user can be inputted to the main controller 60 via an internal communication interface 69. Here, the modes which can be selected by using the mode selection button 54e include a copy mode in which the document P set on the document plate 32 is scanned and copied, a memory card mode in which an image stored in a memory card (not shown) is printed or the document P is scanned and stored in the memory card as data, and a CD/DVD drive mode in which an image in a CD/DVD is printed.

The main controller 60 comprises a microprocessor with a CPU 62 as a core. The main controller 60 includes a ROM 64 in which various kinds of processing programs, various kinds of data, and various kinds of tables are stored, a RAM 66 which temporarily stores scan data and print data, a flash memory 68 which is an electrically rewritable memory and continuously maintains data even if power is not supplied thereto, and an internal communication interface 69 which can communicate with the manipulation panel 50. The elements in the main controller 60 are connected so as to reciprocally exchange signals via the buses 12. The main controller 60 receives various kinds of operation signals and various kinds of detection signals from the printer unit 20 and the scanner unit 30, and receives manipulation signals generated according to manipulations of the buttons 54 of the manipulation panel 50. Further, the main controller 60 outputs instructions to the printer unit 20 so as to perform printing of image data, outputs instructions to the scanner unit 30 so as to read the document mounted on the document plate 36 as image data on the basis of the scan instruction of the buttons 54 of the manipulation panel 50, and outputs control instructions to the display portion 52 of the manipulation panel 50.

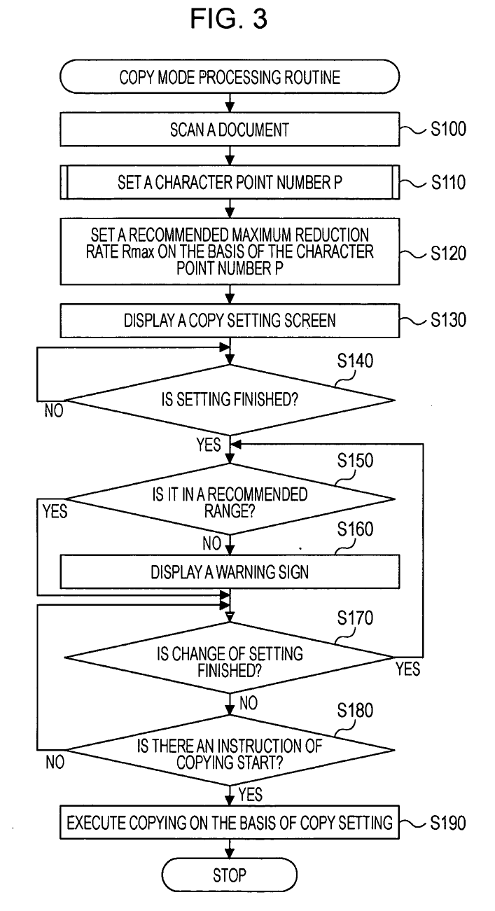

Next, operation of the multi-function printer 10 according to this embodiment of the invention, and particularly operation in the copy mode will be described. FIG. 3 is a flowchart showing an example of a copy mode processing routine executed by the main controller 60. This processing is executed when the OK button 54g is pressed in the state in which the copy mode is selected by the mode selection button 54e and the document P is set on the document plate 32. Further, when the copy mode is selected by the mode selection button 54e, the main controller 60 displays a following message to the display portion 52; “please set a document on a document plate and press an OK button.”

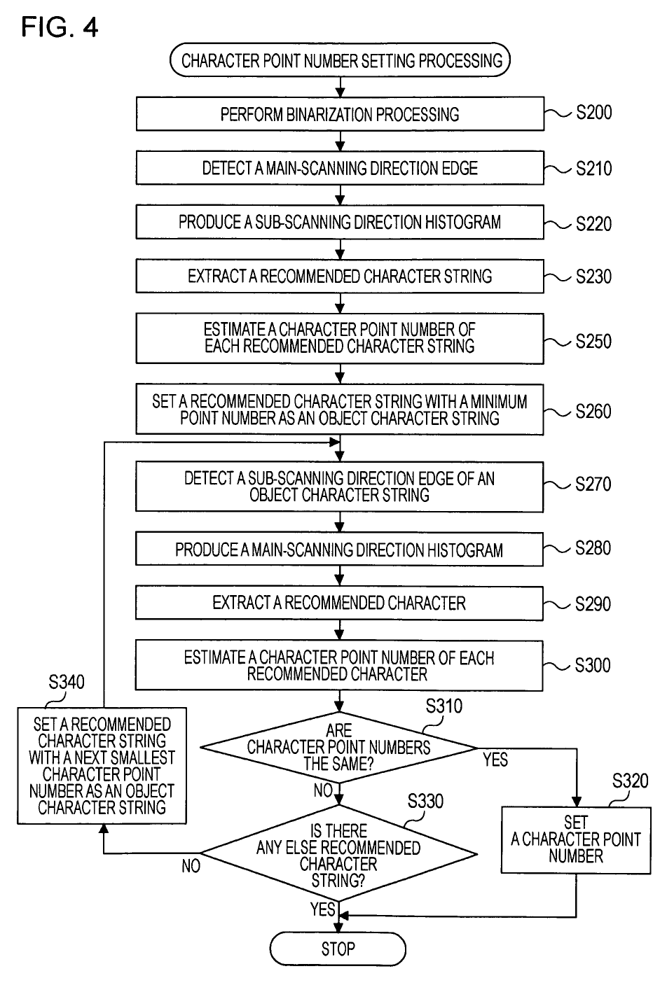

When the copy mode processing routine is executed, the CPU 62 of the man controller 60 scans the document P set on the document plate 32 by outputting a scan instruction to the scanner unit 30 first (Step S100) and then determines a character point number P of characters contained in the document P (Step S110). The determination of the character point number P is performed by the character point determination processing shown in FIG. 4.

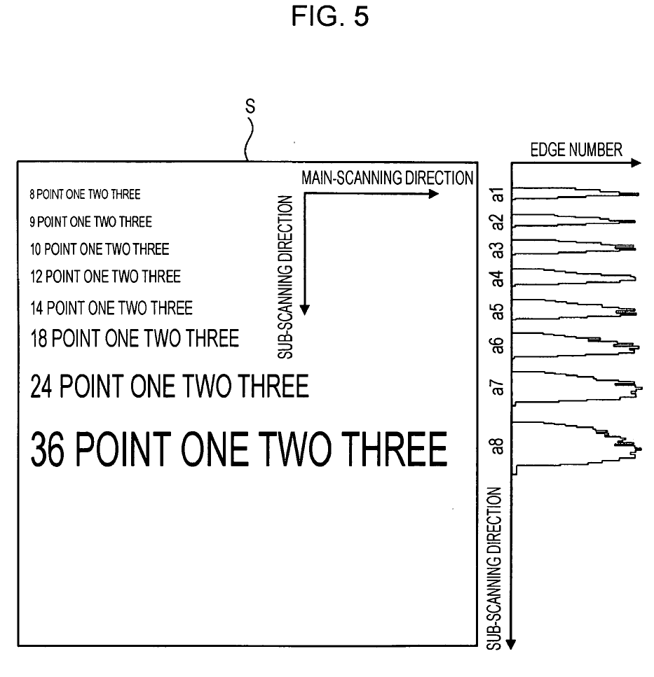

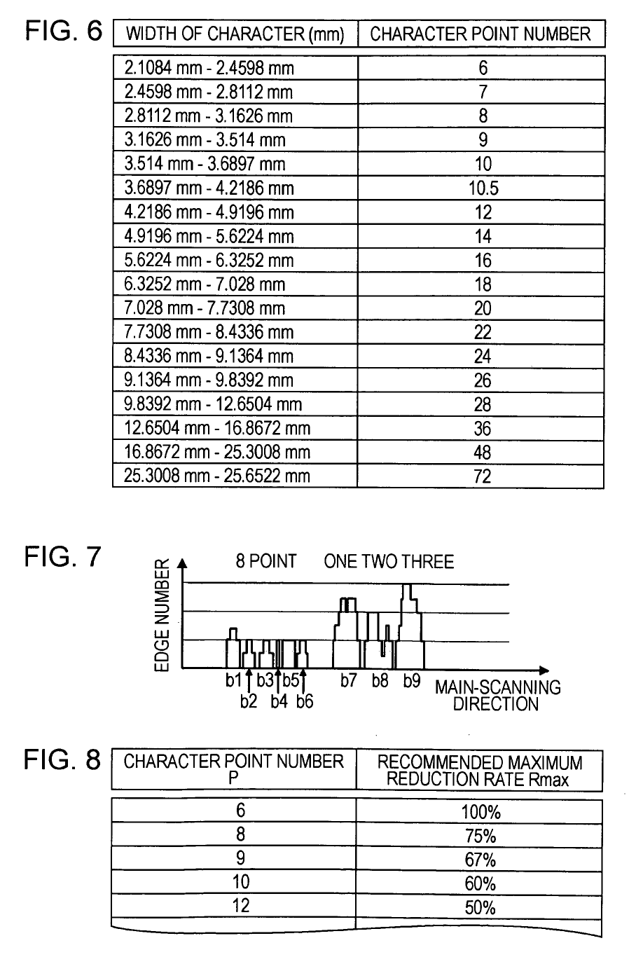

In the character point number determination processing, the image data obtained by scanning the document P is binarized (Step S200), main-scanning direction edges of the binarized image data is detected (Step S210), a sub-scanning direction histogram is produced by accumulating the number of edges (Step S220), and character string candidates are extracted as candidates of a character string contained in the document P using the produced sub-scanning direction histogram (Step S230). An example of the sub-scanning direction histogram is shown in FIG. 5. As shown in this figure, extraction of the character string candidates is performed by determining an area which surrounds an edge value of zero and the determined area is set as character string candidates a1, a2, a3, a4, a5, a6, a7, and a8. Of the extracted character string candidates, a width in a sub-scanning direction is regarded as a character width, and a character point number is estimated on the basis of the character width (Step S250). Here, estimation of the character point number is performed in such a manner that the relationship between the character widths and the character point numbers is stored in the ROM 64 as a map in advance, and the character point number corresponding to the character width in the map is chosen when a certain character width is given. An example of the map is shown in FIG. 6.

If a character point number is estimated with respect to each of the character string candidates, a character string candidate with a minimum character point number of the estimated character point numbers of all the character string candidates (in the case in which the character string candidates with the minimum character point number are plural, one of such character string candidates with the minimum character point number is set) is set as an object character string (a character string candidate al is set as an object character string in FIG. 5) (Step S260), sub-scanning direction edges of the set object character string are detected (Step S270), a main-scanning direction histogram is produced by accumulating the number of edges (Step S280), and character candidates are extracted using the produced main-scanning direction histogram (Step S290). An example of the main-scanning direction histogram is shown in FIG. 7. As shown in this figure, extraction of the character candidates is performed in such a manner that an area which surrounds zero of an edge number is determined and the determined area is set as character candidates b1, b2, b3, b4, b5, b6, b7, b8, and b9. When the character candidates are extracted, a width in the main-scanning direction is determined as a character width of the extracted character candidates, and a character point number is estimated on the basis of the extracted character width (Step S300). Estimation of the character point number is performed on the basis of the character width using the map shown in an example of FIG. 6 in a similar manner with Step S240.

If a character point number of each of the extracted character candidates is estimated, it is determined whether there is a character candidate which satisfies a condition in which the minimum character point number of the character string candidate estimated in Step S260 is the same as a character point number of a character candidate of the estimated character candidates (Step S310), in the case there is such a character candidate, the character point number of the character candidate is set as the character point number (Step S320), and the processing ends. On the other hand, in the case in which there is no such character candidate, it is determined whether there are other character string candidates which are not yet set as object character string of the character string candidates extracted in step S230 (Step S330). When there are other character string candidates which are not set as the object character string, a character string candidate, with a minimum character point number, of these character string candidates is set as the object character string (step S340), and the control is returned to Step S270. With this method, it is possible to estimate a minimum character point number of the characters contained in the document P. At this time, since the character point number is determined using a character which satisfies a condition in which a character width in the main-scanning direction and a character width in the sub-scanning direction are equal to each other, it is possible to more precisely determine the character point number in comparison with the case in which the character point number is determined using a character which satisfies a condition in which a character width in the main-scanning direction and a character width in the sub-scanning direction are not equal to each other. Further, when there are no other character string candidates which are not set as the object character string in Step S330, it is determined such that the character point number P can be determined and the processing ends.

Returning to the copy mode processing routine of FIG. 3, if the character point number P is set in such a manner, a recommended maximum reduction rate Rmax is set on the basis of the set character point number P (Step S120). Here, with this embodiment, the recommended maximum reduction rate Rmax can be determined as the maximum reduction rate Rmax in a range in which a character point number P after performing copying is not smaller than a predetermined value (for example, 6 pt). The relationship between the character point numbers P and the recommended maximum reduction rates Rmax is stored in the ROM 64 as a map in advance. When the character point number P is given, the recommended maximum reduction rate Rmax corresponding to the given character point number P is selected from the map. An example of the map is shown in FIG. 8. The predetermined value also may be a fixed value which is determined in advance, or may be a set value which is set by a user.

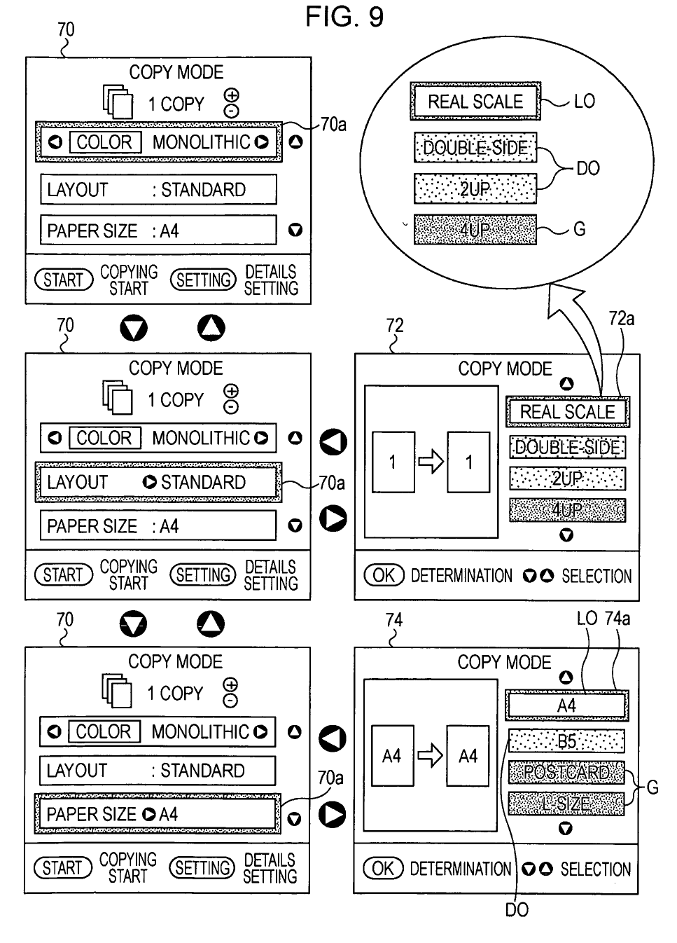

If the recommended maximum reduction rate Rmax is set, a copy setting screen 70 is displayed on the display portion 52 (Step S130). An example of the copy setting screen 70 is shown in FIG. 9. As shown in figures, the copy setting screen 70 is made to allow a user to select each of setting items, such as a layout or a paper size, using the up and down keys of the arrow keys 54f. For layout setting, a cursor 70a is aligned on the middle row in the copy setting screen 70 using the up and down keys of the arrow keys 54f, and then a left key of the arrow keys 54f is pressed. With such operation, a layout setting screen 72 is shown. In the layout setting screen 72, any of a real scale, a double-side, a 2 UP layout in which 4 pages of document are combined and printed into one page, and a 4 UP layout in which 8 pages of document are combined and printed into one page is selected by aligning the cursor 72a using the up and down keys of the arrow keys 54f and pressing the OK button 54g. For paper size setting, a paper size setting screen 74 is shown in a manner such that the cursor 70a is aligned on the lowermost row using the up and down keys of the arrow keys 54f and the right key of the arrow keys 54f is pressed. In the paper size setting screen 74, with the manipulation of the up and down keys of the arrow keys 54f, the cursor 74a is aligned with any one of menu items, A4, B5, postcard, and L-size, and then the OK button 54f is pressed to select the paper size.

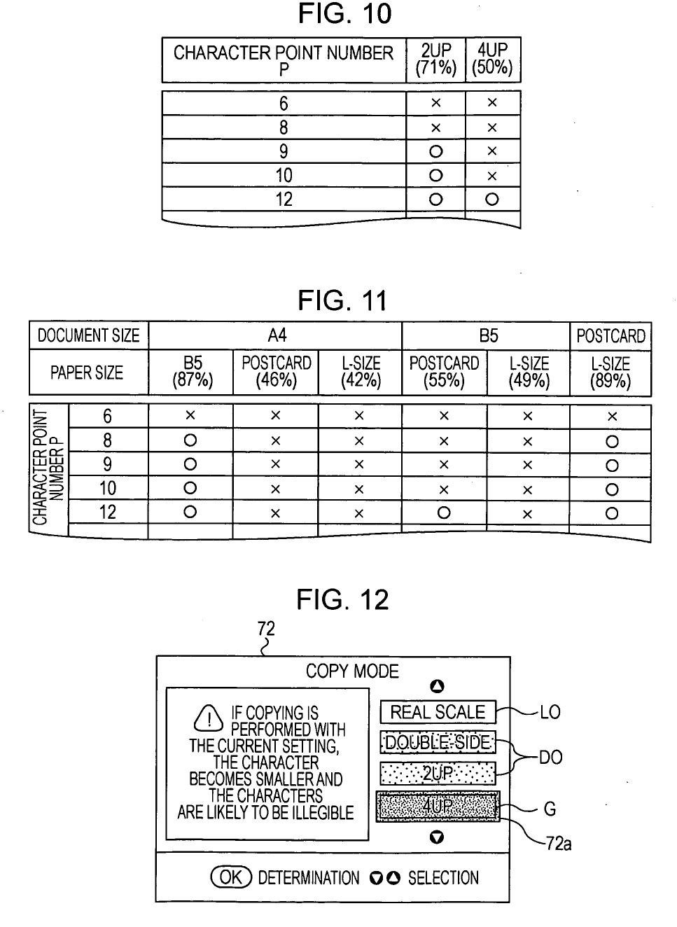

Here, a paper size or a layout in which a reduction rate with respect to the character point number P of the document P is in a range of the recommended maximum reduction rate Rmax, and a paper size and a layout in which the reduction rate with respect to the character point number P of the document P is outside the range of the recommended maximum reduction rate Rmax are displayed in a distinguishable manner for a user. In greater detail, as shown in an enlarged view of the layout setting screen 72 of FIG. 9, the standard layout, which is the real scale, is displayed in light orange (“LO” in the figure), a layout (double-side and 2 Up copy in this embodiment), in which the reduction rate is in a range of the recommended maximum reduction rate Rmax, is displayed in dark orange (“DO” in the figure), and a layout (4 UP copy in this embodiment) in which the reduction rate is outside the range of the recommended maximum reduction rate Rmax, is displayed in gray (“G” in the figure). In the paper size setting screen 74, in the similar manner, A4, which is a standard paper size with respect to a size of the document P (A4 in this embodiment), is displayed in light orange (“LO” in the figure), a paper size (B5 in this embodiment), in which the reduction rate is in a range of the recommended maximum reduction rate Rmax is displayed in dark orange (“DO” in the figure), and a paper size (postcard or L-size in this figure), in which the reduction rate is outside the range of the recommended maximum reduction rate Rmax, is displayed in gray (“G” in the figure). FIG. 10 shows an example of the relationship between the character point number P and the adequacy of a layout of the 2 UP copy or 4 UP copy in the case in which the paper size is a size of the document P. As shown in the figure, when the character point number P of the document P is 6 pt or 8 pt, since the reduction rate is outside the range of the recommended maximum reduction rate Rmax in both of the 2 UP copy and the 4 UP copy layouts, it is determined such that both of the 2 UP copy and the 4 UP copy layouts are not suitable. On the other hand, when the character point number P of the document P is 9 pt or 10 pt, since the reduction rate is in the range of the recommended maximum reduction rate Rmax in the 2 UP copy layout but the reduction rate is outside the recommended maximum reduction rate Rmax in the 4 UP copy layout, it is determined that the 2 UP copy layout is suitable but the 4 UP copy layout is not suitable. When the character point number P of the document P equals to or is greater than 12 pt, since the reduction rate in both of the 2 UP copy and the 4 UP copy layouts is in the range of the recommended maximum reduction rate Rmax, it is determined that both the 2 UP copy and the 4 UP copy layouts are suitable. FIG. 11 shows an example of the relationship between the character point number P and adequacy of a paper size with respect to a size of the document P. FIG. 11 shows only a reduced copy mode in which the paper size is smaller than the document size. In FIG. 11, a value less than the paper size is a reduction rate with respect to the document size. As shown in FIG. 11, when the character point number P of the document P is 6 pt, since the reduction rate is outside the range of the recommended maximum reduction rate Rmax in both of the cases, it is determined such that both of the cases are not suitable. When the character point number P of the document P is 8 pt, 9 pt, or 10 pt, in the case in which the document size is A4 and the paper size is B5, or the case in which the document size is postcard and the paper size is L-size, since the reduction rate is in the range of the recommended maximum reduction rate Rmax, it is determined such that the cases are suitable. However, in the other cases, since the reduction rate is outside the range of the recommended maximum reduction rate Rmax, it is determined such that the cases are not suitable. When the character point number P of the document P is 12 pt, in the case in which the document size is A4 and the paper size is B5, the case in which the document size is B5 and the paper size is postcard, and the case in which the document size is postcard and the paper size is L-size, it is determined such that the reduction rate is in the range of the recommended maximum reduction rate Rmax. However it is determined such that the other cases are not suitable because the reduction rate in the cases is outside the range of the recommended maximum reduction rate Rmax in such cases.

When the copy setting is finished, it is determined whether the current copy setting (layout and paper size) is within a range of the recommended maximum reduction rate Rmax (Step S150). In the case in which the current copy setting is in the range of the recommended maximum reduction rate Rmax, a next processing progresses. In the case in which the current copy setting is outside the range of the recommended maximum reduction rate Rmax, a warning is outputted in such a manner that a warning message, such as “if a copy is performed under the current setting, characters becomes smaller and are likely to be illegible” is displayed on the display portion 52 (Step S160). An example in which the warning message is displayed on the display portion 52 is shown in FIG. 12. FIG. 12 shows a state in which the warning message is displayed when the cursor 72a is aligned with “4 UP” displayed in grey and the OK button 54f is pressed. If the OK button 54f is pressed in this state, the 4 UP copy can be set regardless of the warning message. If the copy setting is changed (Step S170), the processing progresses to Step S150 and subsequent steps starting from Step S150 are repeated. When the start button 54b is pressed and copy starting is instructed (Step S180), copy processing is executed (Step S190) and the main routine ends. The copy processing at the time when either a layout of the 2 UP copy or a layout of the 4 UP copy is selected as the copy setting is performed in such a manner that plural pages of document P which are to be combined into a single page and are set on the document plate 32 is scanned by the scanner unit 30 while changing the plural pages of the document one by one and the image data obtained by the scanning is printed by the printer unit 20 into a single page. At this time, at the time of changing the document, a message “please set another document and press a start button” is displayed on the display portion 52.

Here, the corresponding relationship between elements of the embodiment and elements of the invention will be shown. The main controller 60 which executes the character point number determination process of FIG. 4 according to the embodiment corresponds to “character size determination unit.” The main controller 60 which executes the processing of Step 120, Step 130, Step 150, and Step 160 of the copy mode processing routine of FIG. 3 corresponds to “display control unit.” The main controller 60 which executes the processing of Step 140 and Step 170 of the copy mode processing routine of FIG. 3 corresponds to “reduction rate-related setting receiving unit.” In the embodiment, a control method of the image processing apparatus of the invention will be apparent by explaining the operation of the multi-function printer 10.

According to the multi-function printer 10 of the above-described embodiment, the character point number P of the document P is determined, and a recommended maximum reduction rate Rmax by which a character point number of an output image is not smaller than a predetermined value (6 pt) is set on the basis of the determined character point number P. Then, a layout or a paper size in which a reduction rate is in a range of the recommended maximum reduction rate Rmax and a layout or a paper size in which a reduction rate is outside a range of the recommended maximum reduction rate Rmax are displayed in a layout setting screen 72 or a paper size setting screen 74 in a distinguishable manner. With this manner, a user can determine a recommended layout or paper size or a non-recommended layout or paper size in one glance. Accordingly, it is possible to provide a user with a setting related to a reduction rate which is suitable for copying.

According to the multi-function printer 10 of the embodiment, main-scanning direction edges of image data obtained by scanning the document P are detected and an area in which sub-scanning direction edges gather by accumulating the number of edges is extracted as character string candidates. Then a character point number is estimated. Further, the sub-scanning direction edges of the extracted character string candidates are detected and an area in which the main-scanning direction edges gather by accumulating the number of edges is extracted as character candidates. Then, the character point number is estimated. When there is a character candidate of which a minimum character point number in the character string candidate of the extracted character candidates and a character point number equal are the same, the same character point number is set as the character point number P. Accordingly, it is possible to determine the character point number P using a width of a character having a quadrate shape and it is possible to precisely determine the character point number. Accordingly, it is possible to precisely determine the recommended maximum reduction rate Rmax.

According to the multi-function printer 10 of the embodiment, when a user sets a layout or a paper size in which a reduction rate is outside a range of the recommended maximum reduction rate Rmax, a predetermined warning message is displayed on the display portion 52. Accordingly, it is possible to prevent a user from missetting.

With the embodiment, the recommended maximum reduction rate Rmax is set in such a manner that the character point number of the output image is not smaller than a predetermined value, 6 pt. However, a recommended reduction rate range R may be determined in such a manner that the character point number of the output image is a point number which is in a predetermined range determined by a predetermined uppermost value and a predetermined lowermost value. This embodiment also can obtain the same effect of the embodiment since a layout or a paper size having a reduction rate which is in a recommended reduction rate range R and a layout or a paper size having a reduction rate which is outside the recommended reduction rate range R can be displayed in a distinguishable manner by a user. The predetermined uppermost value and lowermost value can be predetermined fixed values or setting values set by a user.

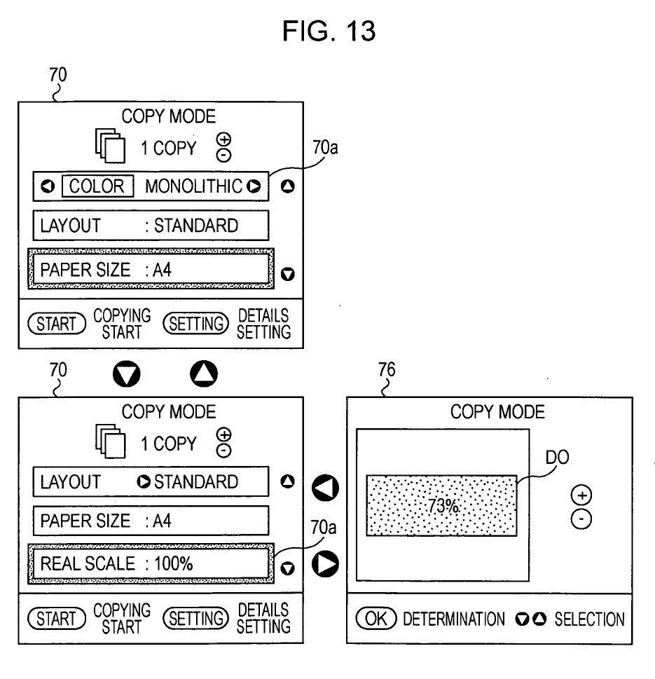

With this embodiment, a reduction rate is indirectly set by setting a layout or a paper size, but the reduction can be directly set. An example of the copy setting screen 70 of this case is shown in FIG. 13. For the setting of the reduction rate, a magnification ratio scale setting screen 76 is shown by pressing the right key of the arrow keys 54f according to a magnification ratio command which is visible when the cursor 70a is moved to a lower row by the setting of a paper size using the up and down key of the arrow keys 54f in the copy setting screen 70. In the magnification ratio setting screen 76, the reduction rate is selected by pressing the OK button 54g at a desired reduction rate after increasing or decreasing a magnification ratio by 1% by manipulation of the “+−” button 54d. The case in which the reduction rate is a standard rate 100, the case in which a reduction rate is in a range of the recommended maximum reduction rate Rmax is displayed, and the case in which a reduction rate is outside a range of the recommended maximum reduction rate Rmax are distinguishably displayed with a light orange color, a dark orange color, and a gray color, respectively. FIG. 13 shows the case in which the reduction rate of 73% is a reduction range which is in a range of the recommended maximum reduction rate Rmax and is a dark orange display (“DO” in the figure.)

With this embodiment, the character point number P is determined as the character size of the document P but is not limited thereto. Any kind of unit can be determined as the character size.

A flat head-type scanner unit 30 is used in the embodiment, but an auto-document feeder-type scanner unit can be used. In this case, the document is continuously scanned and as much image data as possible within memory capacity is stored in a memory. It is possible to apply the character point number determination process exemplified in FIG. 4 to the stored image data.

The embodiments of the invention are described above but the invention is not limited to the embodiments. Many variations of such embodiments can be practiced that are within the technical range of the invention.

What is claimed is:

1. An image processing apparatus connected to a display apparatus so as to receive a received image containing characters and to output the received image at a reduction rate which is set, comprising:
a character size determination unit which determines a determined character size of the received image;
a display control unit which displays a reduction rate-related setting screen for performing a reduction rate-related setting which is related to the reduction rate on the display apparatus on the basis of the determined character size so that a recommended reduction rate-related setting in which a character size of an output image is in a predetermined range and a non-recommended reduction rate-related setting which is other than the recommended reduction rate setting can be distinguishable from each other; and
a reduction rate-related setting receiving unit which receives the reduction rate-related setting using the reduction rate-related setting screen.

2. The image processing apparatus according to claim 1, wherein the display control unit is a unit for determining a recommended reduction rate-related setting in which a character size of an output image is not smaller than a predetermined size as the recommended reduction rate-related setting which is in a predetermined range.

3. The image processing apparatus according to claim 1, wherein the reduction rate-related setting is a setting for setting the number of images to be combined when combining a plurality of images and then outputting them as one image.

4. The image processing apparatus according to claim 1, wherein the reduction rate-related setting is a setting for setting an output size with respect to an input size of the received image.

5. The image processing apparatus according to claim 1, wherein the character size determination unit is a unit which: detects character string direction edges of the received image and extracts an area in which the detected character string direction edges gather in a perpendicular direction as a character string; detects perpendicular direction edges which are perpendicular to the extracted character string and extracts an area in which the perpendicular direction edges gather in the character string direction; and determines a character size on the basis of a width of the extracted character string and a width of the extracted character.

6. The image processing apparatus according to claim 5, wherein the character size determination unit is a unit for determining the character size on the basis of a width when a width of the extracted character string equals to a width of the extracted character.

7. The image processing apparatus according to claim 1, wherein the display control unit is a unit for displaying a predetermined warning screen on the display unit when the reduction rate-related setting, received by the reduction rate-related setting receiving unit, is the non-recommended reduction rate-related setting.

8. A control method of an image processing apparatus connected to a display apparatus so as to receive a received image containing characters and to output the received image at a reduction rate which is set, by using software of a computer, the method comprising:
(a) determining a character size of the received image;
(b) displaying a reduction rate-related setting screen for performing a reduction rate-related setting which is related to the reduction rate on the display apparatus on the basis of a character size which is determined by the step (a) in a manner such that a recommended reduction rate-related setting in which a character size of an output image is in a predetermined range and a non-recommended reduction rate-related setting which is other than the recommended reduction rate setting is distinguishable from each other; and
(c) receiving the reduction rate-related setting using the reduction rate-related setting screen.

9. An image processing apparatus connected to a display apparatus so as to receive a received image containing characters and to output the received image at a reduction rate which is set, comprising:
a first controller which determines a determined character size of the received image;
a display which displays a reduction rate-related setting screen for performing a reduction rate-related setting which is related to the reduction rate on the display apparatus on the basis of the determined character size so that a recommended reduction rate-related setting in which a character size of an output image is in a predetermined range and a non-recommended reduction rate-related setting which is other than the recommended reduction rate setting can be distinguishable from each other; and
a second controller which receives the reduction rate-related setting using the reduction rate-related setting screen.

10. The image processing apparatus according to claim 9, wherein the display is a unit for determining a recommended reduction rate-related setting in which a character size of an output image is not smaller than a predetermined size as the recommended reduction rate-related setting which is in a predetermined range.

11. The image processing apparatus according to claim 9, wherein the reduction rate-related setting is a setting for setting the number of images to be combined when combining a plurality of images and then outputting them as one image.

12. The image processing apparatus according to claim 9, wherein the reduction rate-related setting is a setting for setting an output size with respect to an input size of the received image.

13. The image processing apparatus according to claim 9, wherein the first controller: detects character string direction edges of the received image and extracts an area in which the detected character string direction edges gather in a perpendicular direction as a character string; detects perpendicular direction edges which are perpendicular to the extracted character string and extracts an area in which the perpendicular direction edges gather in the character string direction; and determines a character size on the basis of a width of the extracted character string and a width of the extracted character.

14. The image processing apparatus according to claim 13, wherein the first controller character determines the character size on the basis of a width when a width of the extracted character string equals to a width of the extracted character.

15. The image processing apparatus according to claim 9, wherein the display displays a predetermined warning screen when the reduction rate-related setting, received by the second controller, is the non-recommended reduction rate-related setting.

16. The image processing apparatus according to claim 1, wherein the different colors are used to display the reduced rate-related settings.
